(19) United States
(12) Patent Application Publication
(10) Pub. No.: US 2012/0076906 A1
(43) Pub. Date: Mar. 29, 2012

(54) FLAVOURING INGREDIENT

(76) Inventors: Kasia Aeberhardt, Copponex (FR); François Benzi, Chenex (FR); Simon Linder, Onex (CH); Srini Subramanian, Plainsboro, NJ (US)

(21) Appl. No.: 13/322,618

(22) PCT Filed: Jun. 18, 2010
(86) PCT No.: PCT/IB10/52765

§ 371 Date: Nov. 28, 2011

(30) Foreign Application Priority Data
Jun. 25, 2009 (IB) PCT/IB2009/052744

(51) Int. Cl. A23L 1/22; A23L 1/231

(52) U.S. Cl. 426/534

(57) ABSTRACT

The present invention relates to the field of flavours. More particularly, it concerns the use of a monoglyceride of conjugated linoleic acid as flavouring ingredient. Particularly preferred is the use of the 9,11 isomer of the CLA monoglyceride, such as the 9cis,11trans isomer. CLA monoglycerides enhance or modify butter or beef flavour, for instance.

### TECHNICAL FIELD

The present invention relates to the field of flavours. More particularly, it concerns the use of a monoglyceride of conjugated linoleic acid as flavouring ingredient.

### BACKGROUND AND PRIOR ART

The flavour industry is constantly searching for new flavour ingredients capable of improving the taste of food products. In particular, ingredients capable of improving or modifying the taste of products containing a fat or oil portion are sought.

Mouthfeel, often associated with fatty ingredients such as butter, provides fuller flavours that can be described as more rounded or creamy. Nevertheless, butter-containing foodstuffs are also targeted as products where it would be desirable to be able to reduce the intake of the fatty component without reducing the mouthfeel. Ingredients capable of imparting, enhancing or modifying the mouthfeel of a product are therefore the object of intense research.

To the best of our knowledge, monoglycerides of conjugated linoleic acid (CLA monoglycerides) have never been described as flavouring ingredients.

US 2007/0141220 describes an oil composition comprising from 40 to 95% by weight of CLA diglycerides, from 5 to 60% by weight of CLA triglycerides, and from 0.1 to 10% by weight of CLA monoglycerides. The composition may be used as a food additive having anticancer, immune enhancement, antioxidation, anticholesterol, and growth promotion effects. Nevertheless, the taste of the composition is not even mentioned and CLA monoglycerides are never used by themselves, so that no flavour or mouthfeel effect of this specific ingredient can be expected on the basis of this document, which therefore does not provide any solution to the above-mentioned problems.

US 2005/0013907 describes a food composition based on substances derived from milk comprising an efficient quantity of mono, di and/or triglycerides of one or several active isomers of CLA, to ensure the maintenance of body weight, while at the same time promoting muscle mass at the expense of adipose mass. This document mentions that it is possible to obtain dairy products which do not have the problems of poor taste such as the CLAs in alkyl ester form. Nevertheless, this document only states that CLA monoglycerides do not have the off-note observed with CLAs in alkyl ester form. Any advantageous flavour or taste modifying properties are mentioned or even suggested, so that this document does not provide any solution to the above-mentioned problems.

Thus, it would be desirable to provide ingredients which solve one or more of the problems mentioned above.

### SUMMARY OF THE INVENTION

Accordingly, the present invention provides the use of a monoglyceride of conjugated linoleic acid (CLA monoglyceride) as flavouring ingredient.

The invention further provides a method to confer, enhance or modify the flavour properties of a flavouring composition or of a flavoured article, which method comprises adding to such composition or article an effective amount of a monoglyceride of conjugated linoleic acid.

### DETAILED DESCRIPTION

The present inventors have surprisingly found that a CLA monoglyceride is advantageously used as flavouring ingredient and added to flavoured compositions or articles in order to confer, enhance or modify the flavour and/or the taste, such as mouthfeel, of such composition or product. According to a particular aspect of the invention, such use is very much appreciated by flavourists to impart, enhance or modify the butter, fat or beef flavour and/or the mouthfeel of the composition or article. Preferably, the CLA monogylceride is used in savoury products.

For the purpose of the present invention, a “flavouring ingredient” is defined as a compound used in flavoured compositions or articles to impart a hedonic effect. In other words such an ingredient, to be considered as being a flavouring one, must be recognized by a person skilled in the art as being able to impart, enhance or modify in a positive or pleasant way the flavour or the taste of an article or composition to which it is added. According to a preferred aspect of the invention, the taste that is imparted, enhanced or modified by the flavouring ingredient is the mouthfeel of a composition or article.

Similarly, the expression “flavour properties” of a composition or article means not only the flavour but also the taste, in particular the mouthfeel, of such composition or article.

The “mouthfeel” of a composition or article is defined here as the way such composition or article interacts physically and/or chemically with the interior of the mouth, the teeth and the tongue. Generally, mouthfeel provides fuller flavours which can be described as rounded or creamy. Several specific characteristics of a composition or article are encompassed by the term “mouthfeel”. In a preferred aspect of the invention, a material improves the mouthfeel of a flavouring composition or of a flavoured article when the addition of such material to the composition or article results in one or more of the following effects upon consumption of such composition or article:
reduction of the perceived hardness of the composition or article (force required to bite through the composition or article with front teeth and/or force required to chew the composition or article with molars);
reduction of the perceived grittiness of the composition or article (perception of small hard particles between teethes during chew);
increase of the perceived roundness, creaminess and/or fullness of the composition or article;
increase of the perceived crispiness and/or crunchiness of the composition or article;
increase of the perceived mouthcoating of the composition or article (coating perceived in the mouth after mastication);
reduction of the perceived roughness of the composition or article (perception of the abrasiveness of the composition's or article's surface on the tongue);
increase of the perceived slipperiness of the composition or article over the tongue;
increase of the perceived smoothness (perception of the composition or article as being devoid of particles or lumps).

A CLA monoglyceride is most often found in the form of a mixture of isomers. Any isomer or mixture of isomers of CLA monoglyceride can be used for the purpose of the present invention. Mixtures of isomers comprising the 9,11 isomer as major constituent proved to be particularly advantageous. Therefore it is preferred to use a CLA monoglyceride comprising at least 50%, preferably at least 60%, preferably at least 70%, more preferably at least 80%, most preferably at least 90% of the 9,11 isomer. The 9c,11t isomer, where “c” means “cis isomer” and “t” means “trans isomer”, is most preferred 9,11 isomer.

The CLA monoglyceride can consist of conjugated isomers only or can be a mixture of isomers where part of the isomers are conjugated isomers of linoleic acid and part are non-conjugated isomers of linoleic acid. Preferably the total amount of non-conjugated isomers of linoleic acid present in the monoglycerides is smaller than 40%, more preferably smaller than 30%, even more preferably smaller than 20% and most preferably smaller than 10%.

The CLA monoglyceride is advantageously added to a flavouring composition.

In such a composition the CLA monoglyceride can be admixed with a flavour carrier. In the context of the present invention “flavour carrier” means a material which is substantially neutral from a flavour point of view, insofar as it does not significantly alter the organoleptic properties of flavouring ingredients. The carrier may be a liquid or a solid.

As a liquid carrier, non-limiting examples include an emulsifying system, i.e. a solvent and a surfactant system, or a solvent commonly used in flavours. A detailed description of the nature and type of solvents commonly used in flavour cannot be exhaustive. However, non-limiting examples of suitable solvents include propylene glycol, triacetine, triethyl citrate, benzylic alcohol, ethanol, vegetable oils or terpenes.

As a solid carrier, non-limiting examples include absorbing gums or polymers, or even encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or the materials cited in reference texts such as H. Scherz, Hydrokolloids: Stabilisatoren, Dickungs- and Gehermittel in Lebensmittel, Band 2 der Schriftenreihe Lebensmittelchemie, Lebensmittelqualität, Behr's VerlagGmbH & Co., Hamburg, 1996. Encapsulation is a well known process to a person skilled in the art, and may be performed, for instance, using techniques such as spray-drying, agglomeration, extrusion, coacervation and the like. Spray-dried or extruded solid carriers are preferred.

In a taste-modifying composition according to the present invention, there may be provided a flavour base. In the context of the present invention, “flavour base” means a composition comprising at least one flavouring ingredient which is not a CLA monoglyceride as defined above.

The nature and type of the flavouring ingredients that may be present do not warrant a more detailed description here, which in any case would not be exhaustive, the skilled person being able to select them on the basis of his general knowledge and according to the intended use or application and the desired organoleptic effect. In general terms, these flavouring ingredients belong to chemical classes as varied as alcohols, aldehydes, ketones, esters, ethers, acetates, nitriles, terpenoids, nitrogenous or sulphurous heterocyclic compounds and essential oils, and can be of natural or synthetic origin. Many of these flavouring ingredients are listed in reference texts such as the book by S. Arctander, Perfume and Flavor Chemicals, 1969, Montclair, N.J., USA, or its more recent versions, or in other works of a similar nature, as well as in the abundant patent literature in the field of flavour. It is also understood that the flavouring ingredients may also be compounds known to release in a controlled manner various types of flavouring compounds.

For instance, suitable flavouring compounds for use in combination with the CLA monoglyceride include monosodium glutamate, ribotides, table salt, sucrose, acids, yeast extracts and reaction flavours.

A suitable composition may comprise a flavour adjuvant in combination with the CLA monoglyceride. In the context of the present invention, “flavour adjuvant” means an ingredient capable of imparting an additional added benefit such as color, a particular light resistance, chemical stability, and so on. A detailed description of the nature and type of adjuvants commonly used in flavouring bases cannot be exhaustive, though such ingredients are well known to a person skilled in the art.

A composition consisting of a CLA monoglyceride as defined above and at least one flavour carrier represents a particular embodiment of the invention as well as a flavouring composition comprising a CLA monoglyceride as defined above, at least one flavour carrier, at least one flavour base, and optionally at least one flavour adjuvant.

Moreover, a CLA monoglyceride, as defined above, can be advantageously incorporated into flavoured articles to positively impart or modify, the flavour and/or the taste of such articles. The flavoured articles comprise a foodstuff base. In the context of the present invention, the phrase “foodstuff base” means an edible product, e.g. a food or a beverage. Suitable foodstuff bases include stock cubes, bouillons, instant soups, canned soups, preserved meat, instant noodles, pasta-fillers, frozen dishes and preparations, sauces, dressings, mayonnaise flavoured oils and spreads, fried products, snacks and biscuits. Particularly preferred foodstuffs in which a CLA monoglyceride can be used include biscuits, fried products, sauces, mayonnaise, salad dressings and pasta fillers, among which biscuits, French fries and sauces are mostly preferred.

The nature and type of the constituents of the foodstuffs or beverages do not warrant a more detailed description here, which in any case would not be exhaustive, the skilled person being able to select them on the basis of his general knowledge and according to the nature of said product.

The CLA monoglyceride as defined above is particularly advantageous when added to the oil or fat portion of the food product, even more preferably before processing, typically before cooking, frying or baking.

The proportions in which the CLA monoglyceride as defined above can be incorporated into the various aforementioned articles or compositions vary within a wide range of values. These values are dependent on the nature of the article to be flavoured and on the desired organoleptic effect as well as the nature of the co-ingredients in a given base when the monoglycerides are mixed with flavouring co-ingredients, solvents or additives commonly used in the art.

In the case of flavoured articles, typical concentrations are in the order of 0.1 to 2% by weight, relative to the total weight of the oil or fat portion of the article.

In another aspect, the invention provides a method to confer, enhance or modify the flavour properties of a flavouring composition or of a flavoured article, which method comprises adding to such composition or article an effective amount of a monoglyceride of conjugated linoleic acid.

The CLA monogylceride, the flavouring composition and the flavoured article are as defined above. The flavour properties conferred, enhanced or modified are also described in details above in any specific aspect of the invention. In particular, these flavour properties comprise the flavour and/or the taste, including mouthfeel, of the composition or article, as defined above.

### SPECIFIC EMBODIMENTS OF THE INVENTION OR EXAMPLES

The invention will now be described in further detail by way of the following Examples.

### Example 1

### Preparation of a CLA Monoglyceride

In a first step, a CLA triglyceride was prepared. A solution of methanesulfonyl chloride (origin: Fluka, 42 g, 0.366 mol) in CH₂Cl₂ (300 ml) was added dropwise to a stirred mixture of castor oil (origin: Fluka, 100 g, ca 0.1 mol), Et₃N (40 g, 0.395 mol) and DMAP (4-dimethylaminopyridine, origin: Fluka, 1 g, 8.2 mmol) in CH₂Cl₂ (700 ml) at room temperature under N₂. After 17 hours, the mixture was poured into aq. NaCl and extracted with Et₂O. Workup and concentration in vacuum afforded the crude mesylate (oil) which was dissolved in DBU (origin: Fluka, 200 ml) and heated with stirring at 75° C. during 3 hours. The cooled mixture was poured into cold 15% aq. HCl, extracted with Et₂O and filtered twice through SiO₂ (eluent:cyclohexane/AcOEt 9:1). This synthesis gave 51.6 g of CLA triglyceride oil.

In a second step the CLA monoglyceride was prepared from the obtained CLA triglyceride. The triglyceride (8.5 g, 9.7 mmol) was admixed with glycerol (origin: Fluka, 10.0 g, 108.6 mmol) and Fascat® (SnO(dioctyl)₂, origin: Acima AG, Switzerland, 1.0 g, 2.8 mmol). The mixture was heated under stirring and N₂ to 178-182° C. (inner temp.) for 10 hours. The mixture was then solidified upon cooling and dissolved in 80 ml EtOAc at 40° C. The resulting slurry was filtered over Cellite. The filtrate was then concentrated in vacuum (40° C./100 mbar) to obtain 13.8 g of oil. The oil was then subjected to Medium Pressure Liquid Chromatography (400 g Si60 15-40 μm, cyclohexane/EtOAc 6/4 v/v) and h.v.-dried to obtain 6 g of monoglyceride.

The composition of the obtained CLA monoglyceride is shown in the following table. The percentages are defined by weight relative to the total weight of the CLA monoglyceride.

TABLE 1
composition of the CLA monoglyceride

| Isomer | Amount [%] |
|---|---|
| 9c, 11t | 63 |
| 9c, 11c | 17 |
| 9t, 11t | 6 |
| 9c, 12c | 5 |
| 9c, 12t and 9t, 12t | 7 |
| Minor products | 2 |
| Total | 100 |

### Example 2

### French Fries Containing a CLA Monoglyceride and Sensory Evaluation Thereof

A test sample comprising the CLA monoglyceride obtained in Example 1 and a control sample that does not comprise the CLA monoglyceride were prepared simultaneously.

For the test sample, a 0.5% solution of the CLA monoglyceride prepared in Example 1 in palm oil (origin: Florin, Muttenz, Switzerland) was prepared. An amount of 500 g of this solution was placed in a Trisa electrical fryer (origin: Trisa, Switzerland) and heated to 190° C. Frozen French fries (origin: Coop supermarket, Geneva, Switzerland) were then transferred from the freezer directly to the fryer and fried for 4 minutes with occasional stirring. The fries were then submitted to a sensory evaluation.

The control sample was prepared according to the same method, but with 500 g of palm oil (origin: Florin, Muttenz, Switzerland) without CLA monoglyceride.

The French fries of the control and test samples were immediately presented to 7 trained panellists on a blind test basis. They were asked two questions which are listed in the table below, together with the corresponding panellists answers.

TABLE 2
Results of the sensory evaluation

| Question | Panellists Answers |
|---|---|
| Do you find any difference | 1 panellist didn't find any difference |
| between the two samples? | 6 panellists found a distinct difference |
| Which sample do you prefer? | Of the 6 panellists who found a difference: |
| | 5 panellists preferred the test sample |
| | 1 panellist preferred the control sample |

The 6 panellists who found a difference were also asked to describe the flavour profile and the mouthfeel of each sample. Their answers are summarized in the table below.

TABLE 3
Flavour profile of the test and control samples

| Control Sample | Test Sample |
|---|---|
| more juicy | buttery |
| bitter | more French fries taste |
| green | tastes fresher |
| rancid | crisper |
| wet | slightly more oily and typical |
| | more potatoes taste |
| | more fullness |

### Example 3

### Biscuits Containing a CLA Monoglyceride and Sensory Evaluation Thereof

Three series of biscuits were prepared simultaneously. One control (Biscuit 1) was prepared with a reduced fat margarine. Two test samples (Biscuit 2 and 3) were prepared with the reduced fat margarine and two different amounts of the CLA monoglyceride prepared in Example 1. The composition of the control and of both test samples is provided in the table below.

TABLE 4
Composition of Biscuits 1 to 3

| | Amount [g] | Amount [g] | Amount [g] |
|---|---|---|---|
| Ingredient | in Biscuit 1 | in Biscuit 2 | in Biscuit 3 |
| Salt | 0.34 | 0.34 | 0.34 |
| Whole egg | 8.55 | 8.55 | 8.55 |
| Flour | 34.19 | 34.19 | 34.19 |
| Baking Powder | 0.51 | 0.51 | 0.51 |
| Milk | 5.04 | 5.04 | 5.04 |
| Margarine (80% fat) | 30 | 29.9 | 29.5 |
| CLA monoglycerides | — | 0.1 | 0.5 |
| Sugar | 17.09 | 17.09 | 17.09 |
| Corn starch | 4.27 | 4.27 | 4.27 |

A dry premix was first prepared, by mixing the flour, the corn starch and the baking powder. The whole egg, the milk and the salt were mixed together separately to form a liquid premix.

For biscuits 2 and 3, the CLA monoglyceride was mixed to the 80% fat margarine.

The margarine (Biscuit 1) or the margarine containing the CLA monoglyceride (Biscuits 2 and 3) was whipped with the sugar using a Hobart mixer until the mix was creamy. The liquid premix was then added into the Hobart mixer and blended. The dry premix was then gradually incorporated into the Hobart mixer and blended.

The dough was rolled in a tube shape of a diameter of 2.5 cm and placed in a refrigerator for one hour. Slices of 0.5 cm were then cut and the biscuits were baked during 10 to 12 minutes at 200° C. to 210° C. in a Simon Rotary Test Baking oven.

The biscuits were presented to 10 trained panellists 12 days after their preparation on a blind test basis. The panellists were asked to rate the mouthfeel of the biscuits on the following descriptors on a scale ranging from 0 (very low) to 10 (very high):
Hardness of first bite, which corresponds to the force required to bite though biscuit with front teeth
Hardness of first chew, which corresponds to the force required to chew biscuits with molars
Grittiness, which corresponds to the amount of small hard particles between teeth during chew

The results are summarized in the following table.

TABLE 5
Results of the sensory evaluation of Biscuits 1 to 3

| | Average | Average | Average |
|---|---|---|---|
| | rating in | rating in | rating in |
| | Biscuit 1 | Biscuit 2 | Biscuit 3 |
| Hardness of first bite | 6.00 | 4.90 | 3.90 |
| Hardness of chew | 5.40 | 4.90 | 4.00 |
| Grittiness | 5.00 | 4.20 | 4.60 |

The test samples containing the CLA monoglyceride (Biscuit 2 and Biscuit 3) were perceived as clearly different from Biscuit 1 containing only margarine, with a reduced hardness at first bite and during chewing, and reduced grittiness. These three differences resulted in a clearly improve mouthfeel. The positive effect on hardness of the biscuits was even more perceptible with the highest concentration of CLA monoglyceride.

### Example 4

### Brown Gravy Containing a CLA Monoglyceride and Sensory Evaluation Thereof

Three samples of brown gravy with beef flavour were prepared. The first sample (Gravy 1) was a control without CLA monoglyceride and the other two samples (Gravy 2 and 3) were test samples, each comprising a different concentration of the CLA monoglyceride prepared in Example 1. The composition of the control and the test samples is summarized in the following table.

TABLE 6
Composition of Gravy 1 to 3

| | Amount [g] | Amount [g] | Amount [g] |
|---|---|---|---|
| Ingredient | in Gravy 1 | in Gravy 2 | in Gravy 3 |
| Brown gravy mix base¹⁾ | 19 | 19 | 19 |
| Water | 500 | 500 | 500 |
| Beef flavour²⁾ | 0.5 | 0.5 | 0.5 |
| CLA monoglycerides³⁾ | | 1.25 | 2.5 |

¹⁾Brown Gravy Mix Base GVA-001125, origin: Firmenich SA, Geneva, Switzerland
²⁾Beef 589320 CB, origin: Firmenich SA, Geneva, Switzerland
³⁾Solution of the CLA monoglyceride of Example 1 (1% in EtOH)

The water was mixed with the beef flavour (Gravy 1) or with the beef flavour and the CLA monoglyceride (Gravy 2 and 3). The brown gravy mix base was then dissolved therein and the obtained mixture was stirred and brought to boil.

The brown gravy of the control and test samples were immediately presented to 8 trained panellists on a blind test basis. They were asked two questions which are listed in the table below, together with the corresponding panellists answers.

TABLE 7
Results of the sensory evaluation

| Question | Panellists Answers |
|---|---|
| Do you find any difference | 1 panellist didn't find any difference |
| between the three samples? | 7 panellists found a difference |
| Which sample do you prefer? | Of the 7 panellists who found a difference: |
| | 5 panellists preferred the test samples |
| | (among which 2 preferred Gravy 2 and |
| | 3 preferred Gravy 3) |
| | 2 panellists preferred Gravy 1 (control |
| | sample) |

According to these results, five panellists over eight preferred the mouthfeel of the test samples when compared to the control sample, thus showing the improvement of the mouthfeel due to the use of the CLA monoglyceride. The effect was even more perceivable in the sample comprising the highest concentration of the CLA monoglyceride, since three of the panellists preferred that sample.

1-13. (canceled)

14. A method to confer, enhance or modify the flavour properties of a flavouring composition or of a flavoured article, which method comprises adding to the composition or article an effective amount of a conjugated linoleic acid (CLA) monoglyceride.

15. The method according to claim 14, wherein the CLA monoglyceride comprises at least 50% of the 9,11 isomer.

16. The method according to claim 14, wherein the CLA monoglyceride comprises at least 50% of the 9c,11t isomer.

17. The method according to claim 14, wherein the conferred, enhanced or modified flavour property is a butter or beef flavour.

18. The method according to claim 14, wherein the conferred, enhanced or modified flavour property is mouthfeel.

19. The method according to claim 14, wherein the monoglyceride is added to the flavouring composition or to the flavoured article before processing of the composition or article.

20. The method according to claim 14, wherein the monoglyceride is added to the oil or fat portion of the flavouring composition or flavoured article.

21. The method according to claim 14, wherein the CLA monoglyceride is added in an amount of from 0.1 to 2% by weight, relative to the total weight of the oil or fat portion of the composition or article.
